(19) United States
(12) Patent Application Publication
(10) Pub. No.: US 2006/0081821 A1
(43) Pub. Date: Apr. 20, 2006

(54) Positive temperature coefficient (PTC) polymer composition and resettable fuse made therefrom

(75) Inventors: Jack Jih-Sang Chen, Taipei City (TW); Chi-Hao Gu, Pan-Chiao City (TW); Chang-Cheng Chiang, Hsing-Chuang City (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Fuzetec Technology Co., Ltd.

(21) Appl. No.: 11/294,187

(22) Filed: Dec. 5, 2005

Related U.S. Application Data
(63) Continuation-in-part of application No. 10/435,065, filed on May 8, 2003.

(51) Int. Cl. H01B 1/12

(52) U.S. Cl. 252/500

(57) ABSTRACT

A PTC polymer composition comprises a polymer material, a conductive particulate material dispersed in the polymer material, and a non-conductive filler. The polymer material contains a crystalline grafted polymer selected from the group consisting of grafted polyolefin, grafted polyolefin derivatives, and grafted copolymers of polyolefin and polyolefin derivatives. The grafted polymer is grafted by a polar group selected from the group consisting of carboxylic acids and derivatives thereof. The non-conductive filler comprises a particulate metal oxide material which is dispersed in the polymer material.

### CROSS-REFERENCE TO RELATED APPLICATION

This application is a continuation-in-part (CIP) of U.S. patent application Ser. No. 10/435,065, filed by the applicants on May 8, 2003

### BACKGROUND OF THE INVENTION

1. Field of the Invention

This invention relates to a positive temperature coefficient (PTC) polymer composition, more particularly to a PTC polymer composition with improved voltage resistance and sudden in-rush current resistance.

2. Description of the Related Art

U.S. Pat. No. 6,238,598 (Chen) discloses a PTC polymer composition that comprises a crystalline grafted polymer and a crystalline non-grafted polymer. Addition of the grafted polymer in the polymer composition improves properties, such as peel strength, low contact resistance, low initial resistance, high trip current, and high peak volume resistance, of a PTC element made therefrom.

U.S. Pat. No. 6,359,053 (Chen) discloses a PTC polymer composition that comprises a crystalline grafted polymer, a crystalline non-grafted polymer, and an ionomer of an ionic copolymer of the crystalline non-grafted polymer and an ionized unsaturated carboxylic acid. Addition of the ionic copolymer in the polymer composition improves mechanical properties, such as toughness, good low temperature toughness, high impact strength, and high elasticity, of a PTC element made therefrom.

Circuit protection devices, such as a resettable fuse, made from the aforesaid conventional PTC polymer compositions normally have a low voltage resistance. For instance, a resettable fuse made from the aforesaid conventional PTC polymer compositions, which has a volume resistivity of less than 20 ohm-cm and which is used in applications that operate at about 20 volts, normally has a maximum voltage resistance at about 60 volts, i.e., the resettable fuse will likely burn out when the applied voltage reaches the maximum voltage resistance. Therefore, there is a need to increase the voltage resistance of the aforesaid conventional PTC polymer compositions without sacrificing other properties of the resettable fuse.

Commercial polymeric PTC heater devices are made from polymer compositions that have a volume resistivity of greater than 20 ohm-cm and often greater than 100 ohm-cm. Such heater devices normally operate at a high-voltage condition, e.g., 110-240 Vac or higher (above 600Vac). As such, the polymer composition of this type has a relatively high voltage resistance which does not need to be enhanced further as required by the resettable fuse.

U.S. Pat. No. 4,576,993 (Tamplin et al) discloses low density polyethylene (LDPE) compositions useful in the production of semi-conductive or conductive polymeric materials. The LDPE compositions may contain magnesium oxide.

U.S. Pat. No. 5,378,407 (Chandler et al) discloses conductive polymer compositions which have low resistivity and good electrical stability. The polymer compositions may contain non-conductive filler, such as dehydrated metal oxide, for improvement in resistance stability and flame retardancy thereof. The amount of non-conductive filler contained in the polymer composition preferably ranges from 0 to 20 vol %. The polymer component useful for the polymer composition is preferably a crystalline polymer. Suitable crystalline polymers are polymers of one or more olefins, particularly polyethylene; copolymers of at least one olefin and at least one monomer copolymerisable therewith such as ethylene/acrylic acid, ethylene/ethyl acrylate, and ethylene/vinyl acetate copolymers; melt-shapeable fluoropolymers; and blends of two or more such polymers.

Although addition of the metal oxide in the aforesaid polymer composition of Chandler can improve the resistance stability and flame retardancy of the polymer composition, the voltage resistance and the sudden in-rush current resistance of the polymer composition that contains a polymer selected from the polymers disclosed in the Chandler and Tamplin patents are still relatively poor.

### SUMMARY OF THE INVENTION

Therefore, the object of the present invention is to provide a PTC polymer composition containing a grafted polymer that can provide a synergistic effect on enhancing the voltage resistance and/or the resistance to the sudden in-rush current when combined with a metal oxide.

Another object of this invention is to provide a resettable fuse made from the PTC polymer composition of the present invention.

According to the present invention, there is provided a PTC polymer composition that comprises a polymer material, a conductive particulate material dispersed in the polymer material, and a non-conductive filler. The polymer material contains a crystalline grafted polymer selected from the group consisting of grafted polyolefin, grafted polyolefin derivatives, and grafted copolymers of polyolefin and polyolefin derivatives. The grafted polymer is grafted by a polar group selected from the group consisting of carboxylic acids and derivatives thereof. The non-conductive filler comprises a particulate metal oxide material which is dispersed in the polymer material.

### BRIEF DESCRIPTION OF THE DRAWINGS

Other features and advantages of the present invention will become apparent in the following detailed description of the preferred embodiment with reference to the accompanying drawings, of which:

FIG. 1 shows plots of the maximum voltage resistances for PTC polymer compositions with different concentrations of a crystalline grafted polymer; and

FIG. 2 shows plots of the percentages of passing the sudden in-rush current test for the PTC polymer compositions with different concentrations of a crystalline grafted polymer.

### DETAILED DESCRIPTION OF THE PREFERRED EMBODIMENT

The PTC polymer composition of this invention, which is particularly useful in the manufacture of a circuit protection device, such as a resettable fuse with a volume resistivity at 23° C. of less than 20 ohm-cm, comprises a polymer material, a conductive particulate material (also referred herein as conductive filler) dispersed in the polymer material, and a non-conductive filler.

The polymer material contains a crystalline grafted polymer, and optionally a crystalline non-grafted polymer. The polymer material may further contains an ionic copolymer of the crystalline non-grafted polymer and an ionized unsaturated carboxylic acid. The crystalline grafted polymer is selected from the group consisting of grafted polyolefin, grafted polyolefin derivatives, and grafted copolymers of polyolefin and polyolefin derivatives. The grafted polymer is grafted by a polar group selected from the group consisting of carboxylic acids and derivatives thereof. The crystalline non-grafted polymer is selected from the group consisting of non-grafted polyolefin, non-grafted polyolefin derivatives, and non-grafted copolymers of polyolefin and polyolefin derivatives. The non-grafted polymer has a melting point substantially the same as that of the grafted polymer.

The non-conductive filler comprises a particulate metal oxide material which is dispersed in the polymer material for increasing voltage resistance (i.e., the resistance to damage attributed to an applied voltage) of the PTC polymer composition. For the sake of clarity, a maximum voltage resistance of a resettable fuse is defined herein as a value of the voltage at which the resettable fuse burns out.

The applicants of this invention found that the combination of the crystalline grafted polymer contained in the PTC polymer composition with the particulate metal oxide material can provide a synergistic effect on enhancing the voltage resistance and/or the sudden in-rush current resistance of the PTC polymer composition. Experiments have shown that only the crystalline grafted polymer specified above exhibits the aforesaid synergistic effect when combined with the metal oxide material. Without the grafted polymer in the polymer material of the PTC polymer composition, i.e., only the non-grafted polymer is present in the PTC polymer composition, such as those described in the PTC polymer compositions of the Chandler and Tamplin patents, addition of the metal oxide material cannot achieve the synergistic effect.

Preferably, the polymer material is present in an amount from 20 to 75 wt % of the polymer composition, the conductive particulate material is present in an amount from 20 to 60 wt % of the polymer composition, and the non-conductive filler is present in an amount from 2 to 40 wt % of the polymer composition, and more preferably, the polymer material is present in an amount from 25 to 65 wt % of the polymer composition, the conductive particulate material is present in an amount from 25 to 55 wt % of the polymer composition, and the non-conductive filler is present in an amount from 5 to 30 wt % of the polymer composition. The weight ratio of the grafted polymer to the non-grafted polymer preferably ranges from 95:5 to 5:95, and more preferably ranges from 90:10 to 25:75.

The grafted polyolefin for the crystalline grafted polymer contained in the PTC polymer composition of the preferred embodiment is preferably selected from the group consisting of grafted high density polyethylene (HDPE), grafted low density polyethylene (LDPE), grafted linear low density polyethylene (LLDPE), grafted medium density polyethylene (MDPE), and grafted polypropylene (PP). More preferably, the grafted polyolefin for the crystalline grafted polymer is grafted HDPE. Preferably, the grafted copolymer of polyolefin and polyolefin derivatives is selected from the group consisting of grafted ethylenevinylacetate (EVA) copolymer, grafted ethylene butyl acrylate (EBA) copolymer, grafted ethylene acrylic acid (EAA) copolymer, grafted ethylene methyl acrylic acid (EMAA) copolymer, and grafted ethylene methyl acrylic (EMA) copolymer.

Preferably, the non-grafted polyolefin of the crystalline non-grafted polymer is selected from the group consisting of non-grafted HDPE, non-grafted LDPE, non-grafted LLDPE, non-grafted MDPE, and non-grafted PP. More preferably, the non-grafted polyolefin of the crystalline non-grafted polymer is non-grafted HDPE. Preferably, the non-grafted copolymer of the polyolefin and the polyolefin derivatives is selected from the group consisting of non-grafted EVA, non-grafted EBA, non-grafted EAA, non-grafted EMAA, and non-grafted EMA.

The conductive particulate material (conductive filler) is selected from the group consisting of carbon black, graphite, carbon fiber and metal powder.

The unsaturated carboxylic acid included in the ionomer is selected from the group consisting of maleic anhydride, acrylic acid and acetic acid. Preferably, the unsaturated carboxylic acid is acrylic acid.

The metal oxide material of the non-conductive filler is preferably selected from the group consisting of zinc oxide, aluminum oxide, and magnesium oxide.

The aforesaid synergistic effect and merits of the PTC polymer composition of this invention will become apparent with reference to the following Examples.

### Group 1

### EXAMPLES 1-8 AND COMPARATIVE EXAMPLE 1

Table 1 shows different formulations of the PTC polymer composition for Examples 1-8 (with the grafted HDPE and the non-grafted HDPE) and Comparative Example 1 (with solely the non-grafted HDPE). The weight percentages of the conductive particulate material (carbon black) and the non-conductive filler (aluminum oxide) in Examples 1-8 and Comparative Example 1 are the same, and are respectively 50 wt % and 10 wt %. Test specimens prepared from the formulations listed in Table 1 for each of the Examples and the Comparative Example were subjected to a Voltage resistance test in which the voltage applied to each test specimen was increased at a rate of 10V/min until the specimen reaches the maximum voltage resistance and burns out, and were subjected to a Short circuit test in which a sudden In-Rush current of 20 A is applied to each test specimen at a voltage of 90V. Note that the performance of each of the Examples and the Comparative Example for the Short circuit test is determined by the percentage of the test specimens that pass the Short circuit test, i.e., without burning out. Each test specimen was prepared by compounding and thermal molding the PTC polymer composition to form a PTC element sheet of 0.6 mm, followed by attachment of two copper foils to two opposite sides of the PTC sheet for forming electrodes on the PTC sheet.

TABLE 1

| | | | Conductive | Non-conductive |
|---|---|---|---|---|
| | Polymer material | | filler | filler |
| | Wt % | (grafted:non-grafted) | Wt % | Wt % |
| E*-1 | 40 | 5:95 | 50 | 10 |
| E-2 | 40 | 10:90 | 50 | 10 |
| E-3 | 40 | 25:75 | 50 | 10 |
| E-4 | 40 | 50:50 | 50 | 10 |
| E-5 | 40 | 75:25 | 50 | 10 |
| E-6 | 40 | 90:10 | 50 | 10 |
| E-7 | 40 | 95:5 | 50 | 10 |
| E-8 | 40 | 100:0 | 50 | 10 |
| CE⁺-1 | 40 | 0:100 | 50 | 10 |

E*: abbr. of Example, and
CE⁺: abbr. of Comparative Example.

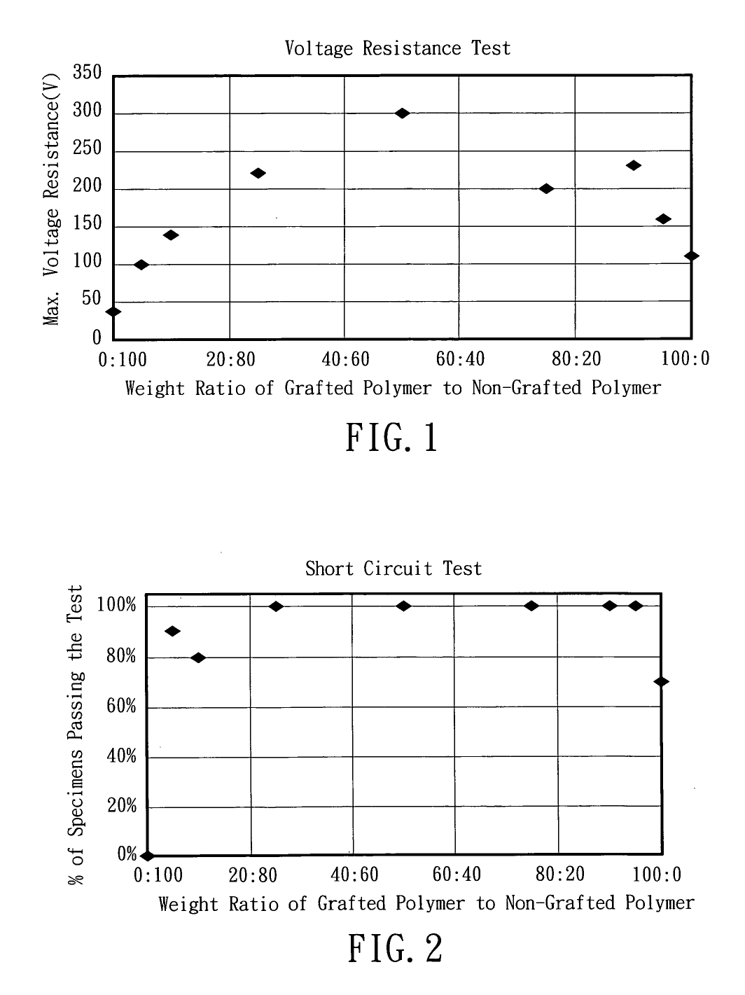

Results of the Voltage resistance test and the Short circuit test for Examples 1-8 and Comparative Example 1 are shown in Table 2 and FIGS. 1 and 2. In addition, the volume resistivity of each of the Examples and the Comparative Example is also shown in Table 2.

TABLE 2

| | | | Short circuit test |
|---|---|---|---|
| | Volume Resistivity | Max. voltage | % of specimens |
| Examples | ohm-cm | resistance V | passing the test |
| E1 | 3.2 | 100 | 90 |
| E2 | 3.1 | 140 | 80 |
| E3 | 2.0 | 220 | 100 |
| E4 | 3.3 | 300 | 100 |
| E5 | 3.3 | 200 | 100 |
| E6 | 3.3 | 230 | 100 |
| E7 | 3.4 | 160 | 100 |
| E8 | 3.4 | 110 | 70 |
| CE1 | 3.6 | 40 | 0 |

The test results show that a relatively large increase in the maximum voltage resistance and in the percentage of specimens passing the short circuit test are achieved when the PTC polymer composition contains the grafted HDPE polymer. The maximum voltage resistance was increased from 40V to 100V and the percentage of the specimens passing the short circuit test was increased from 0% to 90% when the weight ratio of the grafted polymer to the non-grafted polymer was increased from 0:100 (Comparative Example 1) to 5:95 (Example 1). Furthermore, as shown in Table 2, the maximum voltage resistances are greater than 200V and the percentages of the specimens passing the short circuit test were 100% when the weight ratio of the grafted polymer to the non-grafted polymer ranges from 25:75 to 90:10.

### Group 2

### EXAMPLES 9-11 AND COMPARATIVE EXAMPLE 2

Table 3 shows different formulations of the PTC polymer composition for Examples 9-11 (with the grafted HDPE and the non-grafted HDPE) and Comparative Example 2 (with solely the non-grafted HDPE) Group 2 (Examples 9-11 and Comparative Example 2) differs from Group 1 (Examples 1-8 and Comparative Example 1) in that the weight percentages of the polymer material and the conductive filler for the former are respectively 65 wt % and 25 wt %. Test specimens prepared from the formulations listed in Table 3 for each of the Examples and the Comparative Example were subjected to the Voltage resistance test and the Short circuit test under the same test voltages and current as those of Group 1.

TABLE 3

| | | | Conductive | Non-conductive |
|---|---|---|---|---|
| | Polymer material | | filler | filler |
| | Wt % | (grafted:non-grafted) | Wt % | Wt % |
| E-9 | 65 | 10:90 | 25 | 10 |
| E-10 | 65 | 50:50 | 25 | 10 |
| E-11 | 65 | 100:0 | 25 | 10 |
| CE-2 | 65 | 0:100 | 25 | 10 |

Results of the Voltage resistance test and the Short circuit test for Examples 9-11 and Comparative Example 2 are shown in Table 4. In addition, the volume resistivity of each of the Examples and the Comparative Example is also shown in Table 4.

TABLE 4

| | | | Short circuit test |
|---|---|---|---|
| | Volume Resistivity | Max. voltage | % of specimens |
| Examples | ohm-cm | resistance V | passing the test |
| E9 | 10.1 | 220 | 100 |
| E10 | 12.5 | 260 | 100 |
| E11 | 15.6 | 150 | 70 |
| CE2 | 8.5 | 30 | 0 |

Similar to those of Group 1, the test results of Group 2 also show a relatively large increase in the maximum voltage resistance and in the percentage of specimens passing the short circuit test when the PTC polymer composition contains the grafted HDPE polymer. As shown in Table 4, the maximum voltage resistance was increased from 30V to 260V and the percentage of the specimens passing the short circuit test was increased from 0% to 100% when the weight ratio of the grafted polymer to the non-grafted polymer was increased from 0:100 (Comparative Example 2) to 50:50 (Example 10).

### Group 3

### EXAMPLES 12-14 AND COMPARATIVE EXAMPLE 3

Table 5 shows different formulations of the PTC polymer composition for Examples 12-14 (with the grafted HDPE and the non-grafted HDPE) and Comparative Example 3 (with solely the non-grafted HDPE). Group 3 differs from Group 1 in that the weight percentages of the conductive filler and the non-conductive filler for the former are respectively 55 wt % and 5 wt %. Test specimens prepared from the formulations listed in Table 5 for each of the Examples and the Comparative Example were subjected to the Voltage resistance test and the Short circuit test under the same test voltages and current as those of Group 1.

TABLE 5

| | | | Conductive | Non-conductive |
|---|---|---|---|---|
| | Polymer material | | filler | filler |
| | Wt % | (grafted:non-grafted) | Wt % | Wt % |
| E-12 | 40 | 10:90 | 55 | 5 |
| E-13 | 40 | 50:50 | 55 | 5 |
| E-14 | 40 | 100:0 | 55 | 5 |
| CE-3 | 40 | 0:100 | 55 | 5 |

Results of the Voltage resistance test and the Short circuit test for Examples 12-14 and Comparative Example 3 are shown in Table 6. In addition, the volume resistivity of each of the Examples and the Comparative Example is also shown in Table 6.

TABLE 6

| | | | Short circuit test |
|---|---|---|---|
| | Volume Resistivity | Max. voltage | % of specimens |
| Examples | ohm-cm | resistance V | passing the test |
| E12 | 10.4 | 160 | 100 |
| E13 | 1.9 | 140 | 100 |
| E14 | 3.0 | 90 | 40 |
| CE3 | 5.5 | 30 | 60 |

Similar to those of Group 1, the test results also show a relatively large increase in the maximum voltage resistance for Examples E12-E14 and in the percentage of specimens passing the short circuit test for Examples E12 and E13 when the PTC polymer composition contains the grafted HDPE polymer. As shown in Table 6, the maximum voltage resistance was increased from 30V to 160V and the percentage of the specimens passing the short circuit test was increased from 60% to 100% when the weight ratio of the grafted polymer to the non-grafted polymer was increased from 0:100 (Comparative Example 3) to 10:90 (Example 12).

### Group 4

### EXAMPLES 15-17 AND COMPARATIVE EXAMPLE 4

Table 7 shows different formulations of the PTC polymer composition for Examples 15-17 (with the grafted HDPE and the non-grafted HDPE) and Comparative Example 4 (with solely the non-grafted HDPE). Group 4 differs from Group 2 in that the weight percentages of the conductive filler and the non-conductive filler for the former are respectively 30 wt % and 5 wt %. Test specimens prepared from the formulations listed in Table 7 for each of the Examples and the Comparative Example were subjected to the Voltage resistance test and the Short circuit test under the same test voltages and current as those of Group 1.

TABLE 7

| | | | Conductive | Non-conductive |
|---|---|---|---|---|
| | Polymer material | | filler | filler |
| | Wt % | (grafted:non-grafted) | Wt % | Wt % |
| E-15 | 65 | 10:90 | 30 | 5 |
| E-16 | 65 | 50:50 | 30 | 5 |
| E-17 | 65 | 100:0 | 30 | 5 |
| CE-4 | 65 | 0:100 | 30 | 5 |

Results of the Voltage resistance test and the Short circuit test for Examples 15-17 and Comparative Example 4 are shown in Table 8. In addition, the volume resistivity of each of the Examples and the Comparative Example is also shown in Table 8.

TABLE 8

| | | | Short circuit test |
|---|---|---|---|
| | Volume Resistivity | Max. voltage | % of specimens |
| Examples | ohm-cm | resistance V | passing the test |
| E15 | 11.1 | 190 | 100 |
| E16 | 14.3 | 230 | 100 |
| E17 | 16.4 | 120 | 60 |
| CE4 | 9.1 | 30 | 0 |

Similar to those of Group 1, the test results of Group 4 also show a relatively large increase in the maximum voltage resistance and in the percentage of specimens passing the short circuit test when the PTC polymer composition contains the grafted HDPE polymer. As shown in Table 8, the maximum voltage resistance was increased from 30V to 230V and the percentage of the specimens passing the short circuit test was increased from 0% to 100% when the weight ratio of the grafted polymer to the non-grafted polymer was increased from 0:100 (Comparative Example 4) to 50:50 (Example 16).

### Group 5

### EXAMPLES 18-20 AND COMPARATIVE EXAMPLE 5

Table 9 shows different formulations of the PTC polymer composition for Examples 18-20 (with the grafted HDPE and the non-grafted HDPE) and Comparative Example 5 (with solely the non-grafted HDPE). Group 5 differs from Group 1 in that the weight percentages of the polymer material, the conductive filler and the non-conductive filler for the former are respectively 25%, 45 wt % and 30 wt %. Test specimens prepared from the formulations listed in Table 9 for each of the Examples and the Comparative Example were subjected to the Voltage resistance test and the Short circuit test under the same test voltages and current as those of Group 1.

TABLE 9

| | | | Conductive | Non-conductive |
|---|---|---|---|---|
| | Polymer material | | filler | filler |
| | Wt % | (grafted:non-grafted) | Wt % | Wt % |
| E-18 | 25 | 10:90 | 45 | 30 |
| E-19 | 25 | 50:50 | 45 | 30 |
| E-20 | 25 | 100:0 | 45 | 30 |
| CE-5 | 25 | 0:100 | 45 | 30 |

Results of the Voltage resistance test and the Short circuit test for Examples 18-20 and Comparative Example 5 are shown in Table 10. In addition, the volume resistivity of each of the Examples and the Comparative Example is also shown in Table 10.

TABLE 10

| | | | Short circuit test |
|---|---|---|---|
| | Volume Resistivity | Max. voltage | % of specimens |
| Examples | ohm-cm | resistance V | passing the test |
| E18 | 0.7 | 130 | 94 |
| E19 | 0.7 | 180 | 100 |
| E20 | 0.8 | 80 | 0 |
| CE5 | 0.8 | 40 | 0 |

Similar to those of Group 1, the test results also show a relatively large increase in the maximum voltage resistance for Examples E18-E20 and in the percentage of specimens passing the short circuit test for Examples E18 and E19 when the PTC polymer composition contains the grafted HDPE polymer. As shown in Table 10, the maximum voltage resistance was increased from 40V to 180V and the percentage of the specimens passing the short circuit test was increased from 0% to 100% when the weight ratio of the grafted polymer to the non-grafted polymer was increased from 0:100 (Comparative Example 5) to 50:50 (Example 19).

### Group 6

### EXAMPLES 21-23 AND COMPARATIVE EXAMPLE 6

Table 11 shows different formulations of the PTC polymer composition for Examples 21-23 (with the grafted HDPE and the non-grafted HDPE) and Comparative Example 6 (with solely the non-grafted HDPE). Group 6 differs from Group 2 in that the weight percentages of the polymer material and the non-conductive filler for the former are respectively 45 wt % and 30 wt %. Test specimens prepared from the formulations listed in Table 11 for each of the Examples and the Comparative Example were subjected to the Voltage resistance test and the Short circuit test under the same test voltages and current as those of Group 1.

TABLE 11

| | | | Conductive | Non-conductive |
|---|---|---|---|---|
| | Polymer material | | filler | filler |
| | Wt % | (grafted:non-grafted) | Wt % | Wt % |
| E-21 | 45 | 10:90 | 25 | 30 |
| E-22 | 45 | 50:50 | 25 | 30 |
| E-23 | 45 | 100:0 | 25 | 30 |
| CE-6 | 45 | 0:100 | 25 | 30 |

Results of the Voltage resistance test and the Short circuit test for Examples 21-23 and Comparative Example 6 are shown in Table 12. In addition, the volume resistivity of each of the Examples and the Comparative Example is also shown in Table 12.

TABLE 12

| | Volume | | |
|---|---|---|---|
| | Resistivity | Max. voltage | Short circuit test |
| Examples | ohm-cm | resistance V | % of specimens passing the test |
| E21 | 5.6 | 110 | 100 |
| E22 | 5.6 | 120 | 100 |
| E23 | 14.2 | 520 | 100 |
| CE6 | 5.8 | 30 | 20 |

Similar to those of Group 1, the test results of Group 6 also show a relatively large increase in the maximum voltage resistance and in the percentage of specimens passing the short circuit test when the PTC polymer composition contains the grafted HDPE polymer. As shown in Table 12, the maximum voltage resistance was increased from 30V to 520V and the percentage of the specimens passing the short circuit test was increased from 20% to 100% when the weight ratio of the grafted polymer to the non-grafted polymer was increased from 0:100 (Comparative Example 6) to 100:0 (Example 23).

From the test results of the aforesaid voltage test and short circuit test of the Examples 1-23 and the Comparative Examples 1-6, the combination of the grafted polymer specified above and the metal oxide in the PTC polymer composition of this invention provides a synergistic effect on enhancing the voltage resistance and/or the sudden in-rush current resistance.

With the invention thus explained, it is apparent that various modifications and variations can be made without departing from the spirit of the present invention. It is therefore intended that the invention be limited only as recited in the appended claims.

We claim:

1. A positive temperature coefficient (PTC) polymer composition comprising:
a polymer material containing a crystalline grafted polymer selected from the group consisting of grafted polyolefin, grafted polyolefin derivatives, and grafted copolymers of polyolefin and polyolefin derivatives, said grafted polymer being grafted by a polar group selected from the group consisting of carboxylic acids and derivatives thereof;
a conductive particulate material dispersed in said polymer material; and
a non-conductive filler that comprises a particulate metal oxide material which is dispersed in said polymer material.

2. The PTC polymer composition of claim 1, wherein said polymer material is present in an amount from 20 to 75 wt % of the polymer composition, said conductive particulate material is present in an amount from 20 to 60 wt % of the polymer composition, and said non-conductive filler is present in an amount from 2 to 40 wt % of the polymer composition.

3. The PTC polymer composition of claim 1, wherein said polymer material is present in an amount from 25 to 65 wt % of the polymer composition, said conductive particulate material is present in an amount from 25 to 55 wt % of the polymer composition, and said non-conductive filler is present in an amount from 5 to 30 wt % of the polymer composition.

4. The PTC polymer composition of claim 3, wherein said polymer material further contains a crystalline non-grafted polymer selected from the group consisting of non-grafted polyolefin, non-grafted polyolefin derivatives, and non-grafted copolymers of polyolefin and polyolefin derivatives, said non-grafted polymer having a melting point substantially the same as that of said grafted polymer.

5. The PTC polymer composition of claim 4, wherein the weight ratio of said grafted polymer to said non-grafted polymer ranges from 95:5 to 5:95.

6. The PTC polymer composition of claim 4, wherein the weight ratio of said grafted polymer to said non-grafted polymer ranges from 90:10 to 25:75.

7. A positive temperature coefficient (PTC) polymer composition having a volume resistivity of less than 20 ohm-cm, said PTC polymer composition comprising:
a polymer material containing a crystalline grafted polymer selected from the group consisting of grafted polyolefin, grafted polyolefin derivatives, and grafted copolymers of polyolefin and polyolefin derivatives, said grafted polymer being grafted by a polar group selected from the group consisting of carboxylic acids and derivatives thereof;
a conductive particulate material dispersed in said polymer material; and
a non-conductive filler that comprises a particulate metal oxide material which is dispersed in said polymer material;
wherein said polymer material is present in an amount from 20 to 75 wt % of the polymer composition, said conductive particulate material is present in an amount from 20 to 60 wt % of the polymer composition, and said non-conductive filler is present in an amount from 2 to 40 wt % of the polymer composition.

8. The PTC polymer composition of claim 7, wherein said polymer material is present in an amount from 25 to 65 wt % of the polymer composition, said conductive particulate material is present in an amount from 25 to 55 wt % of the polymer composition, and said non-conductive filler is present in an amount from 5 to 30 wt % of the polymer composition.

9. The PTC polymer composition of claim 8, wherein said polymer material further contains a crystalline non-grafted polymer selected from the group consisting of non-grafted polyolefin, non-grafted polyolefin derivatives, and non-grafted copolymers of polyolefin and polyolefin derivatives, said non-grafted polymer having a melting point substantially the same as that of said grafted polymer.

10. The PTC polymer composition of claim 8, wherein said crystalline grafted polymer is selected from the group consisting of grafted HDPE, grafted LDPE, grafted LLDPE, grafted MDPE, and grafted PP.

11. The PTC polymer composition of claim 9, wherein said crystalline non-grafted polymer is selected from the group consisting of non-grafted HDPE, non-grafted LDPE, non-grafted LLDPE, non-grafted MDPE, and non-grafted PP.

12. The PTC polymer composition of claim 8, wherein said conductive particulate material is selected from the group consisting of carbon black, graphite, carbon fiber and metal powder.

13. The PTC polymer composition of claim 8, wherein said metal oxide material is selected from the group consisting of zinc oxide, aluminum oxide, and magnesium oxide.

14. The PTC polymer composition of claim 9, wherein the weight ratio of said grafted polymer to said non-grafted polymer ranges from 95:5 to 5:95.

15. The PTC polymer composition of claim 9, wherein the weight ratio of said grafted polymer to said non-grafted polymer ranges from 90:10 to 25:75.

16. The PTC polymer composition of claim 8, wherein said polymer material further contains an ionic copolymer of said crystalline non-grafted polymer and an ionized unsaturated carboxylic acid.

17. The PTC polymer composition of claim 16, wherein said unsaturated carboxylic acid is selected from the group consisting of maleic anhydride, acrylic acid and acetic acid.

18. A resettable fuse having a volume resistivity of less than 20 ohm-cm, said resettable fuse comprising:
a PTC element having a polymer composition that comprises
a polymer material containing a crystalline grafted polymer selected from the group consisting of grafted polyolefin, grafted polyolefin derivatives, and grafted copolymers of polyolefin and polyolefin derivatives, said grafted polymer being grafted by a polar group selected from the group consisting of carboxylic acids and derivatives thereof,
a conductive particulate material dispersed in said polymer material, and
a non-conductive filler that comprises a particulate metal oxide material which is dispersed in said polymer material; and
two electrodes connected respectively to two opposite sides of said PTC element;
wherein said polymer material is present in an amount from 25 to 65 wt % of the polymer composition, said conductive particulate material is present in an amount from 25 to 55 wt % of the polymer composition, and said non-conductive filler is present in an amount from 5 to 30 wt % of the polymer composition.

19. The resettable fuse of claim 18, wherein said polymer material further contains a crystalline non-grafted polymer selected from the group consisting of non-grafted polyolefin, non-grafted polyolefin derivatives, and non-grafted copolymers of polyolefin and polyolefin derivatives, said non-grafted polymer having a melting point substantially the same as that of said grafted polymer.

20. The resettable fuse of claim 18, wherein said metal oxide material is selected from the group consisting of zinc oxide, aluminum oxide, and magnesium oxide.

21. The resettable fuse of claim 19, wherein the weight ratio of said grafted polymer to said non-grafted polymer ranges from 95:5 to 5:95.

22. The resettable fuse of claim 19, wherein the weight ratio of said grafted polymer to said non-grafted polymer ranges from 90:10 to 25:75.
